(19) United States
(12) Patent Application Publication
(10) Pub. No.: US 2023/0221685 A1
(43) Pub. Date: Jul. 13, 2023

(54) Method and Apparatus for Training and Evaluating an Evaluation Model for a Classification Application

(71) Applicant: Robert Bosch GmbH, Stuttgart (DE)

(72) Inventors: Konrad Groh, Stuttgart (DE); Matthias Woehrle, Bietigheim-Bissingen (DE)

(21) Appl. No.: 18/153,805

(22) Filed: Jan. 12, 2023

(30) Foreign Application Priority Data
Jan. 13, 2022 (DE) 10 2022 200 290.3

(51) Int. Cl. G05B 13/04; G05B 13/02

(52) U.S. Cl. CPC G05B 13/042; G05B 13/027

(57) ABSTRACT

A method evaluates a trained data-based evaluation model for determining a model output for controlling, regulating, operating, or monitoring a technical system with periodically determined input data sets. The method includes recording input data sets for a predetermined number of time-sequential scanning steps, and aggregating the input data sets into an input data package of validated input data sets. The method further includes determining an evaluation result for each of the input data sets in the input data package using the trained data-based evaluation model. Upon each evaluation, one or more model parameters of the trained data-based evaluation model are reduced by an amount or set to 0. The method is further configured to aggregate the evaluation results to obtain the model output.

This application claims priority under 35 U.S.C. § 119 to patent application no. DE 10 2022 200 290.3, filed on Jan. 13, 2022 in Germany, the disclosure of which is incorporated herein by reference in its entirety.

The disclosure relates to a method for providing an evaluation model for classifying input data from a sensor system, and in particular to measures for robustly determining a classification result and a confidence value for this purpose.

### BACKGROUND

Sensors to record physical parameters are often continuously scanned. For example, using a suitable sensor, a pressure, a mass flow, an acceleration, a temperature, a vibration, a camera image, audio information, or the like may be recorded. The sensor or the sensor system then generally provides a sensor value, a sensor signal time series or image information as an electrical or digitalized signal for each scanning step. These sensor data typically form an input data set for further processing in an evaluation model.

Such an input data set can be analyzed and evaluated for evaluation. In particular, evaluation models may be configured as a data-based regression model or a classification model such that the input data set is associated with at least one regression result or at least one classification result.

### SUMMARY

According to the disclosure, there is provided a method for evaluating sensor signal data using a data-based evaluation model for determining a classification result, and a corresponding device.

According to a first aspect, a method of evaluating a provided trained data-based evaluation model is provided for determining a model output for controlling or monitoring a technical system with periodically determined input data sets, with the following steps:

recording of input data sets for a predetermined number of time-sequential scanning steps;

aggregating the input data sets into an input data package of validated input data sets;

determining an evaluation result for each of the input data sets in the input data package using the data-based evaluation model, wherein, upon each evaluation, one or more model parameters of the evaluation model are reduced by amount or set to 0; and

aggregating the individual evaluation results to obtain the model output.

It may be contemplated that the data-based evaluation model includes an artificial neural network having one or more layers of artificial neurons, wherein the model parameters for each of the neurons include weights of a weighting vector and a bias value.

Furthermore, the input data sets may comprise one or more sensor signals, in particular in the form of one or more state variables, one or more sensor signal time series, and/or image data.

The model output of data-based evaluation models, particularly neural networks, is typically highly reliable when the input data set to be evaluated is within the data points of the training data sets used for the training. For input data sets outside the data space of the training data, the confidence of a model prediction by the neural network can only be evaluated with high uncertainty. However, for safety-critical applications, it is necessary to provide an improved confidence score for the model output of a data-based evaluation model that is highly reliable.

There are generally various ways to associate confidence values with the model output of a data-based evaluation model. However, such methods are often not suitable for use in limited computational time budgets, such as is often the case in embedded systems, such as mobile devices, IoT devices, or control devices of mobile technical systems. In the case of classification models as evaluation models in particular, the determination of confidence or the degree of uncertainty using ensembles and the calculation of Softmax confidences is too unreliable and inaccurate.

However, when evaluating input datasets using a data-based evaluation model, an indication of their reliability is often required, especially when safety-critical functions are determined by the model output. Thus, a basic problem exists in providing an easy way for computational time budgeted systems to provide reliable model output along with an indication of its confidence value. The confidence value of a model output of a data-based classification model allows to discard corresponding model outputs with too low confidence value or to consider the confidence value in a fusion system as additional parameters and thereby to improve a prediction of a fused initial quantity.

For this purpose, it may be provided that a confidence value for the model output is determined using the evaluation results, which is used in the control and/or monitoring of the technical system, in particular wherein the confidence value is indicated as dependent on a scattering or a standard deviation or a variance of the evaluation results.

The above method of determining a model output by evaluating input data sets using a data-based evaluation model provides for gathering and co-evaluating a number of successive input data sets into an input data package. For the input data sets of the input data package, the corresponding evaluation results are now determined using the data-based evaluation model. Each time the data-based evaluation model is evaluated, the model parameters, i.e., the weightings of the neurons in a neural network as a data-based evaluation model, are modified. In particular, the one or more model parameters of the evaluation model may be reduced in amount or set to 0, and in particular may be selected randomly.

That is, each calculation of an evaluation result regarding one of the input data sets in the input data package is based on a calculation having at least one, preferably several, varied model parameters. Thus, the at least one or more varied model parameters have values that differ from values assigned by a training of the data-based evaluation model. The number of model parameters being reduced in amount or set to 0 may be between 1% and 10%, preferably between 5% and 20%, of the total number of model parameters.

The input data sets of the input data package yield varying evaluation results, which can now be summarized with regard to an aggregated model output and can additionally provide a statement about the confidence of the model output.

According to one embodiment, the aggregation of the evaluation results can be carried out with a mean value formation, with a median formation, with a determination of the minimum or maximum value or a determination of the variance, wherein in particular with classification vectors as the evaluation results the class is output as the model output that results from a majority decision.

The aggregated model output may be determined, respectively in a regression as a mean or median of the evaluation results. When classified, the aggregated model output may correspond to a majority of the class maps of the model outputs.

Accordingly, the confidence value may result as a standard deviation of the model outputs. Depending on the scattering of the model outputs with respect to the input data sets of the input data package, a confidence value may in particular be given proportional to a reciprocal value of the scattering or the standard deviation.

The above method of determining a model output by evaluating input data sets using a data-based evaluation model utilizes the continuity of input data sets. Thus, according to the above method, it is necessary that only those input data sets are evaluated that change only moderately, such as image data of the same scene recorded at a high scanning frequency, time series data of repetitive operations in a technical system with limited dynamic change, and the like.

Particularly, the input data is provided according to a scanning frequency to obtain input data sets. The input data sets include one or more sizes, each of which may be provided as a single value, a time series, and/or as map data. The input data sets are aggregated into input data packages from successive input data sets, wherein the input data packages each comprise a predetermined number of input data sets recorded from successive scanning steps. In this case, an input data package is valid if a change measurement for a change of the individual input data sets is below a predetermined change threshold between two successive and/or between any two scanning steps within the input data package. For example, the change may be determined using a distance dimension, such as a Euclidean distance between the input data sets.

The provision of the input data sets may be performed using a shift register that always contains a number of the most recently acquired input data sets. Each new input data set shifts the previous entries of the shift register. An evaluation according to the above methods is then always carried out based on the entries in the registers of the shift register.

If the evaluation of the neural network is determined with a higher frequency than is necessary for prediction, several evaluations of the neural network for successive input data sets can also be stored in the shift register from which the model output and the confidence value can then be determined by aggregation. After such an evaluation, the shift register is deleted and used for a new evaluation.

This procedure for determining a model output has the advantage that a noise behavior of the input data can also be taken into account.

It may be contemplated that the trained data-based evaluation model be trained based on training datasets corresponding to labelled input datasets, wherein, with a portion or with each iteration, model parameters are reduced in amount or set to 0. Thus, when training the data-based evaluation model to determine an evaluation result with training data sets, the model parameters of the data-based evaluation model shaped in the form of a neural network, may adjusted or changed based on a function that randomly modifies the weighting parameters of individual neurons.

It may be contemplated that the input data sets of the input data package will be validated if it is determined that two temporally adjacent input data sets have a clearance that is not greater than a predetermined distance threshold and/or if it is determined that two input data sets have a clearance that is not greater than a predetermined distance threshold.

This checks that the scanning frequency of the scanning steps is relatively high compared to the physical information to be measured or to changes in the measuring range, so that input data sets are acquired that only slightly change from time increment to time increment. For example, a recorded camera image may be scanned at scanning frequencies of 10 to 200 Hz to record images from a recording range that only slightly change due to movement of objects in the real world. Also, periodically recurring signal patterns, such as the pressure profile of an injection system of an internal combustion engine described below, may be recorded as time series data that changes only slowly compared to the recording frequency due to comparatively slow changes in the operating state of the internal combustion engine. Accordingly, the predetermined distance threshold noted above is selected such that the change in information in the input datasets does not become too great. In particular, exceeding a distance threshold is intended to indicate that the state of the underlying system or the situation in the measurement range has fundamentally changed.

According to a further aspect, a device for carrying out one of the above methods is provided.

### BRIEF DESCRIPTION OF THE DRAWINGS

Embodiments are explained in more detail in the following with reference to the accompanying drawings. Here:

FIG. 1 shows a schematic representation of a sensor system for determining model output using a data-based evaluation model,

FIG. 2 shows a flow chart illustrating a method for determining a model output using a data-based evaluation model,

FIG. 3 shows a schematic illustration of the construction of a deep neural network as an evaluation model;

FIG. 4 shows a schematic representation of an injection system for injecting fuel into the cylinder of an internal combustion engine; and

FIG. 5 shows, by way of example, an evaluation signal curve of a sensor signal for a pressure sensor of the injection system of FIG. 4.

### DETAILED DESCRIPTION

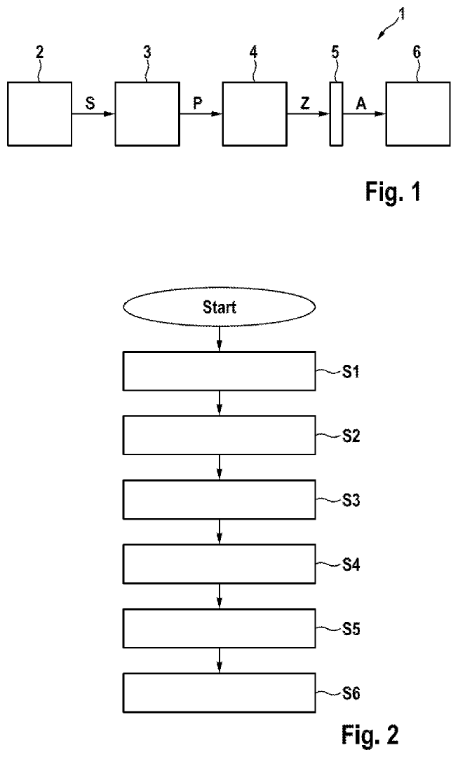

FIG. 1 shows a sensor system 1 having a sensor arrangement 2 with one or more sensors for the continuous scanning of physical information. For example, the sensor assembly 2 may correspond to a pressure sensor, a mass flow sensor, a temperature sensor, an accelerometer, a vibration sensor, and/or a radiation sensor for recording a physical measured quantity and/or a camera, a lidar sensor, a radar sensor for recording map data, or the like.

The sensor 2 is scanned at a scanning frequency in scanning steps to obtain an input data set for each scanning step. Each of the input data sets may comprise value and/or image information and/or time-series information and/or moving image information recorded within the respective scanning step.

In conjunction with the flowchart, the method used in the sensor system 1 to evaluate the input data sets is described in more detail.

The scanning of the physical information to determine the input data sets is done in step S1.

The scanning frequency of the scanning steps is relatively high compared to the physical information to be measured or to changes in the measuring range, so that input data sets S are acquired that only slightly change from time increment to time increment. For example, a recorded camera image may be scanned at scanning frequencies of 10 to 200 Hz to record images from a recording range that only slightly change due to movement of objects in the real world. Also, periodically recurring signal patterns, such as the pressure profile of an injection system of an internal combustion engine described below, may be recorded as time series data that changes only slowly as a result of comparatively slow changes in the operating state of the internal combustion engine compared to the recording frequency.

In step S2, the input data sets are combined in a pre-processing block 3 in a package to form an input data package P, in which several temporally successive input data sets S are compiled for a respective recording time for a common evaluation.

The provision of the input data sets S may be performed using a shift register that always contains a number of the most recently acquired input data sets S. For example, each new input data set S may shift the stored input data packages P of the shift register. An evaluation according to the above methods is then always carried out based on the entries in the registers of the shift register that form the input data package.

The shift register can be maintained or deleted after each model evaluation.

An input data package P is generated only if the change indicated with a distance dimension between temporally adjacent input data sets S is below a predetermined distance threshold and/or if the change indicated with the distance dimension between any two input data sets S in the input data package P is below a predetermined further distance threshold. The size of the input data package P may comprise between 10 and 100 input data sets S. The input data package P is thus compiled from each input data sets S of a predetermined number of scanning steps and is validated accordingly. Input data packages P that cannot be validated due to too high of a clearance will be discarded and the model evaluations that were previously carried out based on validated input data packages P will be used.

If it is determined that several consecutive input data sets have not been validated, this can be signaled accordingly.

For evaluation, in step S3 the input data package P is supplied to a data-based evaluation model 4. Here, each individual input data set S is evaluated with the trained data-based evaluation model 4 in order to obtain a respective evaluation result Z. The evaluation is respectively performed by a variation of one or more selected model parameters. In so doing, the relevant selected model parameters are set to 0 or are reduced in their amount according to a predetermined factor (of <1).

The evaluation results Z are aggregated or combined to a model output in an aggregation block 5.

In an evaluation model configured as a neural network, for each evaluation one or more selected weighting parameters may be varied individually. In so doing, the selected weighting parameters may be reduced to 0 or according to a predetermined factor. The selection of the connections between neurons of successive layers turned off or weakened by this can be done randomly. The number of model parameters modified in this way is preferably not greater than 20%, further preferably not greater than 10%.

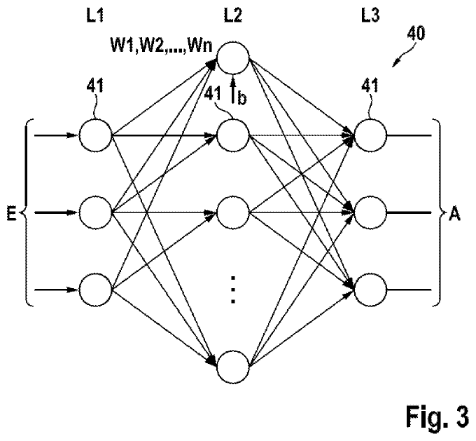

The evaluation model 4 is preferably configured as a neural network. FIG. 3 schematically shows the construction of a deep neural network 40 as an example for an evaluation model 4 with several layers L, which in the embodiment example shown correspond to an input layer L1, an inner layer L2 and an output layer L3, each with several neurons 41.

Each neuron 41 performs a function on supplied inputs of an input data set S from each neuron of the previous layer or the resulting input vector E, respectively. The function includes a summation of weights of weighted inputs and a bias value. The weightings W1, W2, . . . , Wn are provided by a weighting matrix for the respective layer, the bias value b is provided by a bias vector predetermined for the respective layer. The sum value is further supplied to a non-linear activation function, for example, which may correspond to a ReLU function. The weightings W1, W2, . . . , Wn of all neurons 41 and the bias values of all neurons 41 in the case of a neural network correspond to the model parameters of the evaluation model 4.

As usual, the neurons are each assigned a function that calculates a sum of starting values of neurons of a previous neuron layer that are weighted with weighting parameters or from input values of the elements of the corresponding input data set S plus a neuron-specifically predetermined bias value and application of an activation function.

By randomly selecting individual weighting parameters, which are reduced in amount or set to 0, the output of the evaluation model 4 can be documented with a noise. This procedure is carried out for each of the input data sets S of the input data package P and the corresponding evaluation results Z are evaluated.

The evaluation results may correspond to one or more regression values in a regression model as evaluation model 4. Alternatively, the evaluation model may correspond to a classification model that classifies the input data sets S and outputs a classification vector as a classification result, in which each element corresponds to its own class. The element value then determines how likely the input-side predetermined sensor signal data is associated with a particular class.

The fusion or aggregation of the individual evaluation results Z into an aggregated model output occurs in step S5 using a corresponding aggregation block 5. For example, in classification vectors as evaluation results Z, the aggregated model output may be determined by elementally averaging all classification results and subsequent determination of a class determined by the index value of the element having the maximum value (argmax). Alternatively, the class of the aggregated model output may be determined by a majority decision of the classification results, i.e., that class of the index value of the classification result is output as an overall result corresponding to the class determined by the majority of the classification results. Alternative decision functions may also be used.

In the case of regression values as evaluation results Z, they can be averaged or medianized to obtain the aggregated model output.

Furthermore, in step S5, a scattering or standard deviation of the evaluation results Z can be determined as a confidence value, for example by application of a histogram, wherein, for example, the reciprocal value of the scattering or standard deviation may indicate the confidence value for the aggregate model output.

The model output of the evaluation model 4 and the aggregation block 5 as well as the confidence value serve to control, regulate or otherwise operate a technical system 6 in a predetermined manner in step S6.

In this way, it is possible to obtain a reliable model output with associated confidence value by gathering a predetermined amount of input data sets S determined by scanning in successive time increments. The model output may now be used for subsequent functions, wherein the use may be made depending on the determined confidence value. Alternatively, the confidence value may also be used in data fusion, in particular if the particular model output has also been obtained via another measurement method.

The data-based evaluation model may be trained on training datasets having the format of the input datasets S along with associated label as model output. The training may be performed according to a self-recognized training method, such as back propagation. In doing so, one or more model parameters or weighting parameters of one or more randomly selected neurons are set to 0 or decreased by the predetermined factor.

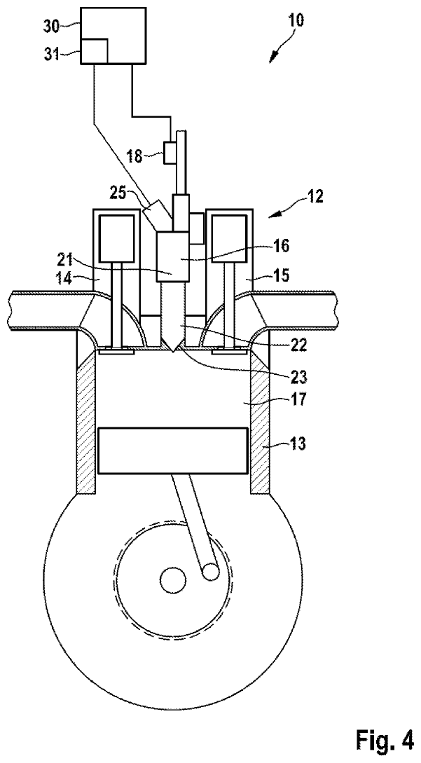

FIG. 4 shows as an example a sensor system 1 an injection system 10 for an internal combustion engine 12 of a motor vehicle, for which a cylinder 13 (of in particular several cylinders) is shown by way of example. The internal combustion engine 12 is preferably designed as a direct-injection diesel engine but may also be provided as a gasoline engine.

The cylinder 13 comprises an intake valve 14 and an exhaust valve 15 for supplying fresh air and exhausting combustion exhaust.

Furthermore, fuel for operating the internal combustion engine 12 is injected into a combustion chamber 17 of the cylinder 13 via an injection valve 16. To this end, fuel is provided to the injection valve via a fuel supply 18, via which fuel is provided in a manner known per se (e.g., common rail) under a high fuel pressure.

The injection valve 16 comprises an electromagnetically or piezoelectrically controllable actuator unit 21 coupled to a valve needle 22. In the closed state of the injection valve 16, the valve needle 22 is seated on a needle seat 23. By controlling the actuator unit 21, the valve needle 22 is moved longitudinally and releases a portion of a valve opening in the needle seat 23 in order to inject the pressurized fuel into the combustion chamber 17 of the cylinder 13.

The injection valve 16 furthermore comprises a piezo sensor 25 arranged in the injection valve 16. The piezo sensor 25 is deformed by pressure changes in the fuel conducted by the injection valve 16 and is generated by a voltage signal as a sensor signal.

The injection takes place in a manner controlled by a control unit 30 which specifies an amount of fuel to be injected by energizing the actuator unit 21. The sensor signal is scanned over time using an A/D converter 31 in the control unit 30, in particular at a scanning frequency of 0.5 to 5 MHz.

Furthermore, a pressure sensor 18 is provided to determine a fuel pressure upstream of the injector 16.

During operation of the internal combustion engine 12, the sensor signal is used to determine a correct opening or closing time of the injection valve 16. For this purpose, the sensor signal is digitized into an evaluation point time series by means of the A/D converter 31 and evaluated by a sensor model 4 as example for an evaluation model, from which an open duration of the injection valve 16 and correspondingly an injected fuel quantity can be determined as a function of the fuel pressure and other operating variables. In particular, in order to determine the opening duration, an opening time and a closing time are needed to determine the opening duration as the time difference of these parameters.

The determination of an opening time and/or a closing time may be performed by an evaluation of input data sets S comprising the evaluation point time series of the sensor signal and the fuel pressure using a data-based sensor model as the evaluation model.

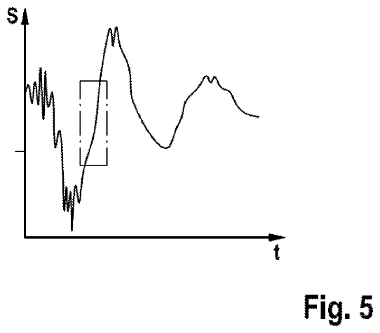

In connection with the above sensor system 1, the scanned evaluation signal time series is part of the input data set S and may be sensed cyclically depending, on the RPMs of the internal combustion engine. Evaluation signal processes take place, for example as shown in FIG. 5, from which an evaluation point time series of the sensor signal is derived by scanning within an evaluation time window. These change little from recording cycle to recording cycle, as changes in the state of the internal combustion engine typically occur much slower than the frequency of an operating cycle of the internal combustion engine. Thus, consecutive evaluation signal time series can be recorded and provided as part of the input data set S in each scanning step. These are temporarily stored and validated in pre-processing block 3 for their uniformity, meaning it is determined whether the change within a predetermined number of successive input data sets S of an input data package is sufficiently low, as described above.

Such a validated input data package P is now supplied to the sensor model corresponding to a data-based classification model. The data-based classification model is trained to output a classification vector that determines a change point time at which an opening or closing time of the injector is present. The index value of the element of the classification vector with the highest value (argmax) determines the time to be determined. According to any of the above methods, the classification results of the evaluated evaluation results may now be merged in order to determine an overall classification result as the model output. This indicates the change point time that can be used for subsequent functions. For example, determining the opening or closing timing of the injector may be used to determine the actual amount of fuel injected.

Due to the further possibility of determining the confidence value from the evaluation results of the input data sets S of the respective input data package P, the particular opening and/or closing time can be discarded, for example in the event of too much uncertainty, and the preceding opening or closing time can instead be used as a reliable opening or closing time.

As a further embodiment example, a camera system in an automotive vehicle can be assumed as a sensor system that is oriented in a direction of travel of the vehicle. The technical system corresponds to an assistance system that is configured to perform a subsequent drive, i.e., the distance to a vehicle in front is to be kept constant upon activation of the corresponding function.

For this purpose, image data is recorded by the camera system in regular scanning steps and provided as input data sets S. These input data sets S are aggregated into validated input data packages P, as described above. As the preceding situation generally changes only slightly when the vehicle is subsequently driven, the input data sets S can often be identified as validated input data sets S. The evaluation is performed using the assistance system in which the data-based evaluation model is implemented. Depending on image data recorded dependent on each other, the evaluation model may determine a distance to the vehicle ahead as input data sets S, and based thereon trigger a corresponding response of the own vehicle, for example, signaling a decreasing or increasing distance to the vehicle ahead.

The confidence value resulting from the evaluations of the several evaluation results may be used for a response of the assistance system, respectively. For example, with a confidence value above a threshold, higher speeds may be offered or set for subsequent drives than with an underlying confidence value. Further, the confidence value may be utilized to automatically position the vehicle within the lane through corresponding steering movements. Thus, it may travel off-centered in the lane to optimize the confidence value with respect to distance determination to the vehicle ahead.

What is claimed is:

1. A method of evaluating a trained data-based evaluation model determines a model output for controlling, regulating, operating, or monitoring a technical system with periodically determined input data sets, the method comprising:
recording input data sets for a predetermined number of time-sequential scanning steps;
aggregating the input data sets into an input data package of validated input data sets;
determining an evaluation result for each of the input data sets in the input data package using the trained data-based evaluation model, wherein, upon each evaluation, one or more model parameters of the trained data-based evaluation model are reduced by an amount or set to 0; and
aggregating the evaluation results to obtain the model output.

2. The method according to claim 1, wherein the input data sets comprise one or more sensor signals.

3. The method according to claim 1, wherein:
the trained data-based evaluation model comprises an artificial neural network having one or more layers of artificial neurons, and
the one or more model parameters, for each of the neurons, comprise weights of a weighting vector and a bias value.

4. The method according to claim 1, further comprising:
randomly selecting the one or more model parameters of the trained data-based evaluation model that are reduced by the amount or set to 0.

5. The method according to claim 4, wherein the number of model parameters that are reduced by the amount or set to 0 corresponds to between 1% and 20% of a total number of the one or more model parameters.

6. The method according to claim 1, wherein:
the trained data-based evaluation model is trained based on training datasets corresponding to labelled input data sets, and
with a portion or with each iteration, randomly selected model parameters are reduced by the amount or set to 0.

7. The method according to claim 1, further comprising:
determining a confidence value for the model output using the evaluation results,
wherein the confidence value is used in a controller, a regulation, an operation, and/or a monitoring of the technical system.

8. The method according to claim 1, wherein:
aggregating the evaluation results is performed with averaging or with a median formation.

9. The method according to claim 1, wherein the input data sets of the input data package are validated when it is determined that two time-adjacent input data sets have a clearance that is not greater than a predetermined distance threshold and/or when it is determined that two input data sets have a clearance that is not greater than a predetermined distance threshold.

10. The method according to claim 1, further comprising:
using the model output to control and/or monitor the technical system.

11. A device for carrying out the method according to claim 1.

12. A computer program product including instructions which, when executing the computer program product by a computer, cause the computer to execute the method according to claim 1.

13. A non-transitory machine-readable storage medium comprising instructions which, when executed by a computer, cause the computer to carry out the method according to claim 1.

14. The method according to claim 2, wherein the one or more sensor signals are configured as one or more state variables, one or more sensor signal time series, and/or image data.

15. The method according to claim 7, wherein the confidence value is indicated depending on a scattering, a standard deviation, or a variance of the evaluation results.

16. The method according to claim 8, wherein aggregating the evaluation results is performed with classification vectors as the evaluation results and a class is output as the model output that results from a majority decision.
